(19) United States
(12) Patent Application Publication
(10) Pub. No.: US 2019/0322083 A1
(43) Pub. Date: Oct. 24, 2019

(54) HARD COAT FILM

(71) Applicant: NIPPON PAPER INDUSTRIES CO., LTD., Tokyo (JP)

(72) Inventors: Daichi ANDO, Tokyo (JP); Takayoshi NOMURA, Tokyo (JP); Yusuke SUGIYAMA, Tokyo (JP); Tsukasa NAKAJIMA, Tokyo (JP); Souta YUUKI, Tokyo (JP)

(73) Assignee: NIPPON PAPER INDUSTRIES CO., LTD., Tokyo (JP)

(21) Appl. No.: 16/470,861

(22) PCT Filed: Dec. 16, 2017
(86) PCT No.: PCT/JP2017/045227

§ 371 Date: Jun. 18, 2019

(30) Foreign Application Priority Data
Dec. 19, 2016 (JP) 2016-244994

(51) Int. Cl. B32B 23/08; B32B 27/16; B32B 27/32

(52) U.S. Cl. CPC B32B 23/08; B32B 27/16; B32B 27/322; B32B 2307/418; B32B 2255/10; B32B 2305/30; B32B 2307/412; B32B 2250/02

(57) ABSTRACT

A hard coat film that, while maintaining excellent antiglare properties, can suppress the brightness irregularity, and has excellent visibility of a display. The hard coat film includes a hard coat layer containing organic fine particles and an ionizing radiation-curable resin on a transparent film. Moreover, a difference (|nx−ny|) of the refractive index (nx) of the ionizing radiation-curable resin and the refractive index (ny) of the organic fine particles contained in the hard coat layer is 0.03 or larger.

### TECHNICAL FIELD

The present invention relates to a hard coat film.

### BACKGROUND ART

A resolution power of a display mounted on a laptop computer is drastically improved due to an advancement of display technology. In the laptop computer, in order to prevent reflection of ambient light such as a fluorescent lamp or sun light, an antiglare film having high antiglare properties is used. However, accompanying the higher resolution power of the display, due to the antiglare film, brightness irregularity occurs on a screen.

In a hard coat film having large surface roughness such as proposed in, for example, JP 2002-185927 A (Patent Document 1), although the antiglare properties may be obtained, the brightness irregularity occurs strongly due to surface irregularity of the hard coat film to deteriorate the visibility.

On the other hand, although it is considered to design so as to lower the surface irregularity to suppress the brightness irregularity, the reflection of the external light is intense to deteriorate the visibility of a screen.

In a low haze antiglare film such as proposed in, for example, JP 2011-507167 A (Patent Document 2), although the brightness irregularity may be suppressed, the antiglare properties are low to deteriorate the visibility of a screen.

### PRIOR ART DOCUMENTS

### Patent Documents

Patent Document 1: JP 2002-185927 A

Patent Document 2: JP 2011-507167 A

### SUMMARY OF THE INVENTION

### Problem to be Solved by the Invention

In a conventional technology, when a hard coat layer that makes the surface irregularity milder to suppress the brightness irregularity is designed, the deterioration of the visibility due to the deterioration of the antiglare properties was cared. Furthermore, there was a problem that when the antiglare properties are improved by enhancing the surface irregularity for improving the antiglare properties, the brightness irregularity is deteriorated.

There, in the present invention, it is the problem to provide a hard coat film that, while maintaining excellent antiglare properties, can suppress the brightness irregularity, and has excellent visibility of a display.

### Means for Solving the Problem

The present inventors found, after studying hard, that the problem may be solved when the following constitutions are provided. That is, the present invention has inventions (1) to (10) having the following constitutions.

(1) A hard coat film having a hard coat layer containing organic fine particles and an ionizing radiation-curable resin on a transparent film, in which a difference (|nx−ny|) of the refractive index (nx) of the ionizing radiation-curable resin and the refractive index (ny) of the organic fine particles is 0.03 or larger.

(2) A hard coat film having a hard coat layer containing organic fine particles and an ionizing radiation-curable resin on a transparent film, in which a difference (|nx−ny|) of the refractive index (nx) of the ionizing radiation-curable resin and the refractive index (ny) of the organic fine particles is 0.03 or larger, a haze value of the hard coat film is 5% or larger and 50% or smaller, and the scratch resistance load is 200 g or larger.

(3) The hard coat film according to (1) or (2) including two or more kinds of the organic fine particles having different average particle sizes, in which an organic fine particles A showing a maximum average particle size contained in the hard coat layer has an average particle size of 2 μm or larger and 5 μm or smaller.

(4) The hard coat film described in any one of (1) to (3), in which an average gradient angle of an irregularity of a surface of the hard coat film is 2.1 degree or smaller.

(5) The hard coat film described in any one of (1) to (4), in which, when an average value of heights in an evaluation area of the surface of the hard coat film is set to zero, a maximum cross-section height represented by a difference of a maximum value of a height in the evaluation area and a minimum value of a height in the evaluation area is 3.0 μm or smaller.

(6) The hard coat film described in any one of (1) to (5), in which the diffuse reflectance of the hard coat film is 4.0% or smaller.

(7) The hard coat film described in any one of (1) to (6), in which the transmissive sharpness of the hard coat film is 155% or larger and 320% or smaller, and the glossiness is 30% or larger and 80% or smaller.

(8) The hard coat film described in any one of (1) to (7), in which a haze value of the hard coat film is 8% or larger and 35% or smaller, and an external haze value is 1% or larger and 30% or smaller.

(9) The hard coat film described in any one of (1) to (8), in which an antireflective layer containing a fluororesin is laminated on the hard coat layer.

(10) The hard coat film described in any one of (1) to (9), in which the transparent film is a triacetyl cellulose film.

### Effect of the Invention

According to the present invention, a hard coat film that, while maintaining excellent antiglare properties, may suppress the brightness irregularity and has excellent visibility of a display may be provided.

### MODE FOR CARRYING OUT THE INVENTION

In what follows, an embodiment of the present invention will be described in more detail.

That is, the present invention relates to a hard coat film that is a film having a hard coat layer containing organic fine particles and an ionizing radiation-curable resin on a transparent film, in which a difference (|nx−ny|) of the refractive index (nx) of the ionizing radiation-curable resin and the refractive index (ny) of the organic fine particles is 0.03 or larger.

A transparent film base material that may be used in the present invention is not particularly restricted, but, for example, a polyethylene terephthalate film (PET; refractive index 1.665), a polycarbonate film (PC; refractive index 1.582), a triacetyl cellulose film (TAC; refractive index 1.485), and a norbornene film (NB; refractive index 1.525) may be used, and a film thickness is neither restricted but about 25 μm to 250 μm may be generally used. Since the refractive index of the general ionizing radiation-curable resin is about 1.52, in order to enhance the visibility, the TAC film and NB film close to the refractive index of the resin are preferable, and the TAC film is particularly preferable. Furthermore, the PET film is preferable from the viewpoint of cost.

It is important that the hard coat layer of the present invention is imparted with the hardness (pencil hardness, scratch resistance) on a surface of the hard coat layer and that the ionizing radiation-curable resin is used in a point that a large amount of heat is not required when forming the hard coat layer.

Such ionizing radiation-curable resin may be appropriately selected from, for example, urethane acrylate-based resins, polyester acrylate-based resins, and epoxy acrylate-based resins. As ones preferable as the ionizing radiation-curable resin, in order to obtain excellent adhesiveness with a transparent base material, ones made of UV-curable polyfunctional acrylate having two or more (meth)acryloyl groups in a molecule may be used. Specific examples of the UV-curable polyfunctional acrylates having two or more (meth)acryloyl groups in a molecule include polyol-polyacrylates such as neopentyl glycol di(meth)acrylate, 1,6-hexanediol di(meth)acrylate, trimethylol propanetri (meth)acrylate, ditrimetylol propane tetra(meth)acrylate, pentaerythritol tetra(meth)acrylate, pentaerythritol tri(meth)acrylate, and dipentaerythritol hexa(meth)acrylate; epoxy(meth)acrylates such as diacrylate of bisphenol A diglycidyl ether, diacrylate of neopentyl glycol diglycidyl ether, and di(meth)acrylate of 1,6-hexane diol glycidyl ether; polyester (meth)acrylate obtained by esterifying polyalcohol and polycarboxylic acid and/or its anhydride and acrylic acid, urethane(meth)acrylate, polysiloxane poly(meth)acrylate obtained by reacting polyalcohol, and polyisocyanate and hydroxyl group-containing (meth)acrylate.

The UV-curable polyfunctional acrylates may be used singularly or used by mixing two or more kinds, and its content is preferably 50 to 95 wt. % relative to a resin solid content of a coating material for a hard coat layer. By the way, other than the polyfunctional (meth)acrylate, preferably, 10 wt. % or lower of monofunctional acrylate such as 2-hydroxy(meth)acrylate, 2-hydroxypropyl(meth)acrylate, or glycidyl (meth)acrylate may be also added to the resin solid content of the coating material for a hard coat layer.

Furthermore, a polymerizable oligomer that is used to adjust the hardness may be added to the hard coat layer. Examples of the oligomers like this include macromonomers such as terminal (meth)acrylate polymethyl(meth)acrylate, terminal styryl poly(meth)acrylate, terminal (meth)acrylate polystyrene, terminal (meth)acrylate polyethylene glycol, terminal (meth)acrylate acrylonitrile-styrene copolymer, and terminal (meth)acrylate styrene-methyl methacrylate copolymer. Its content is preferably 5 to 50 wt. % relative to the resin solid content in the hard coat coating material.

The refractive index (nx) of the ionizing radiation-curable resin that forms the hard coat layer like this is expressed by an average refractive index after curing all ionizing radiation-curable resins used in the hard coat layer and is preferably in the range of 1.50 to 1.55, and more preferably in the range of 1.51 to 1.53.

It is important that organic fine particles are contained in the hard coat layer of the present invention. Although the material that forms such organic fine particles is not particularly restricted, for example, a vinyl chloride resin (refractive index 1.53), an acrylic resin (refractive index 1.49), a (meth)acrylic resin (refractive index 1.52 to 1.53), a polystyrene resin (refractive index 1.59), a melamine resin (refractive index 1.57), a polyethylene resin, polycarbonate resin, acryl-styrene copolymer resin (refractive index 1.49 to 1.59), or a silicone resin (refractive index 1.42) may be used.

The organic fine particles like this preferably have an average particle size of 0.1 to 5 μm. When the average particle size is outside of the present range, it is difficult to obtain a balance between the antiglare properties and the brightness irregularity.

As the organic fine particles of the present invention, organic fine particles having two or more kinds of different average particle sizes may be used.

An organic fine particles A having a largest average particle size contained in the hard coat layer has preferably an average particle size of 2 μm to 5 μm, more preferably an average particle size of 3 μm to 5 μm, and still more preferably an average particle size of 4 μm to 5 μm. When the average particle size of the organic fine particles A is in the present range, a balance between the antiglare properties and the brightness irregularity tends to be readily obtained.

By the way, in the present invention, the average particle size is a length average diameter of the fine particles and may be measured by, for example, a laser diffraction particle size meter SALD 2200 (manufactured by Shimadzu Corporation).

The organic fine particles A like this is contained preferably in the range of 70 to 100 wt. % relative to all organic fine particles contained in the hard coat layer.

Furthermore, organic fine particles other than the organic fine particles A contained in the hard coat layer have preferably an average particle size of 0.1 to 0.9 time the average particle size of the organic fine particles A and more preferably an average particle size of 0.4 to 0.7 time.

The refractive index (ny) of the organic fine particles of the present invention means an average refractive index of all organic fine particles contained in the hard coat layer like this, and it is important that the difference of the refractive indices (|nx−ny|) is 0.03 or larger relative to the refractive index (nx) of the ionizing radiation-curable resin contained in the hard coat layer (by the way, description of |AA| expresses an absolute value of AA). When the difference of the refractive indices (|nx−ny|) satisfies the present range, the balance between the antiglare properties and the brightness irregularity may be established, the difference of the refractive indices (|nx−ny|) is preferably 0.05 or larger, more preferably 0.07 or larger, and still more preferably 0.09 or larger, and when the difference is 0.1 or larger, the effect of the present invention may be more readily obtained. An upper limit of the difference of the refractive indices (|nx−ny|) is preferably 0.2 or smaller, and more preferably 0.15 or smaller.

The hard coat layer of the present invention may further contain, as needs arise, a levelling agent, a defoarming agent, a lubricant, an UV absorber, a light stabilizer, a polymerization inhibitor, a wetting dispersant, a rheology control agent, an antioxidant, an antifouling agent, an antistatic agent, and a conductive agent, in the range that does not damage the effect of the invention.

Although a method of forming the hard coat layer of the present invention is not particularly restricted and a well-known method may be used, for example, the ionizing radiation-curable resin and the organic fine particles are dispersed in a solvent, and a dispersed coating material is coated on a transparent film and dried to form.

As a solvent, a solvent that may be appropriately selected according to the solubility of the ionizing radiation-curable resin and may uniformly dissolve or disperse at least a solid content (ionizing radiation-curable resin, organic fine particles, other additives) may be used. Examples of the solvent like this include ketones (acetone, methyl ethyl ketone, methyl isobutyl ketone, and cyclohexanone), ethers (dioxane, and tetrahydrofuran), aliphatic hydrocarbons (hexane), alicyclic hydrocarbons (cyclohexane), aromatic hydrocarbons (toluene and xylene), halogenated carbons (dichloromethane and dichloroethane), esters (methyl acetate, ethyl acetate and butyl acetate), alcohols (methanol, ethanol, isopropanol, butanol, and cyclohexanol), cellosolves (methyl cellosolve and ethyl cellosolve), cellosolve acetates, sulfoxides, and amides. These solvents may be used singularly or in a mixture thereof.

Although a coating method is not particularly limited, methods which may readily adjust a coating film thickness such as a gravure coating method, a micro-gravure coating method, a bar coating method, a slide die coating method, a slot die coating method, and a dip coating method may be used to coat. By the way, a film thickness of the hard coat film may be measured by observing a film cross-section photograph with a microscope (for example, a scanning electron microscope SEM) and by actually measuring from a coating film interface to a surface.

The hard coat film of the present invention has preferably an average gradient angle of irregularity of its surface of 2.1 degree or smaller, more preferably of 0.1 degree or larger and 1.8 degree or smaller, and still more preferably of 0.1 degree or larger and 1.5 degree or smaller.

The “average gradient angle” is obtained in such a manner that a cross-section curve (measurement curve) of a film surface that is a target of measurement is separated in a lateral direction by a constant interval ΔX, an absolute value of a gradient of a line binding start and end points of a cross-section curve in each interval (gradient angle: the gradient angle is obtained as tan⁻¹(ΔYi/ΔX).) is obtained, followed by averaging the values.

When the average gradient angle is 2.1 degree or smaller, an effect of the present invention that while maintaining excellent antiglare properties, the brightness irregularity may be suppressed, and high optical property (visibility) are obtained may be readily obtained.

Furthermore, in the hard coat film of the present invention, when an average value of heights in an evaluation area of its surface is set to 0 (zero), a maximum cross-section height (Rt) that is expressed by a difference between a maximum value of the height in the evaluation area and a minimum value of the height in the evaluation area is preferably 3.0 μm or smaller, and more preferably 2.0 μm or smaller.

Here, although the “maximum cross-section height” is as defined above, as defined also in JIS B0601, it is a value calculated from the cross-section curve of a film surface that is a measurement target. A surface of the hard coat film obtained by providing a hard coat layer containing the fine particles and the resin like in the present invention has not only a fine irregular pattern but also an undulation. A measurement curve measured by a surface roughness meter (usually called as a cross-section curve) has relationship between the undulation curve and the roughness curve of

cross-section curve=undulation curve+roughness curve. Therefore, the “maximum cross-section height” in the present invention evaluates a cross-section curve containing a “surface undulation component”. By the way, in JIS, the maximum cross-section height is expressed by a mark “Rt”.

Since, when the maximum cross-section height is 3.0 μm or smaller, excellent anti-glare properties and a suppression effect of irregular brightness are developed with good balance, further, and a balance with the hardness important as the hard coat film is also excellent, the effect of the present invention tends to be more readily obtained.

Furthermore, the hard coat film of the present invention has the diffuse reflectance preferably of 4.0% or smaller, and more preferably of 3.0% or smaller.

In the present invention, the diffuse reflectance is a value measure by a method described below, and an index of the antiglare property.

When the diffuse reflectance is 4.0% or smaller, the effect of the present invention that, while maintaining excellent antiglare properties, the brightness irregularity may be suppressed tends to be obtained.

Furthermore, the hard coat film having the hard coat layer of the present invention obtained as shown above has the transmissive sharpness preferably of 155% or larger and 320% or smaller, more preferably of 200% or larger and 310% or smaller, and still more preferably of 220% or larger and 305% or smaller. Still furthermore, the glossiness is preferably 30% or higher and 80% or lower, more preferably 40% or higher and 75% or lower, and still more preferably 45% or higher and 55% or lower.

When the transmissive sharpness and glossiness are in the above range, the effect of the present invention becomes more readily obtained.

Furthermore, the hard coat film of the present invention has the haze value preferably of 5% or higher and 50% or lower, more preferably of 5% or higher and 45% or lower, still more preferably of 5% or higher and 40% or lower, and particularly preferably of 8% or higher and 35% or lower. The hard coat film of the present invention may, while suppressing the haze value to a certain extent, be provided with excellent antiglare properties and have a balance between the antiglare properties and the brightness irregularity. Furthermore, the external haze value is preferably 1% or higher and 30% or lower.

Furthermore, the hard coat film of the present invention is provided with excellent hardness properties on a surface of the hard coat layer. Specifically, the scratch resistance load measured according to a method described below is 200 g or larger. That is, the hard coat film of the present invention may, while maintaining excellent antiglare property, suppress the brightness irregularity and has excellent hardness properties (hardness).

In the hard coat film of the present invention, on the hard coat layer, an antireflective layer may be further provided. As the antireflective layer, for example, with a Y value of the tristimulus values based on JIS Z 8701 as the reflectance, the reflectance is preferably 2% or lower.

The antireflective layer like this is important to contain a fluororesin. As the fluororesin, a compound having at least one polymerizable unsaturated double bond and at least one fluorine atom may be used, and the specific examples thereof include (1) fluoro-olefines such as tetrafluoroethylene, hexafluoropropylene, 3,3,3-trifluoropropylene, and chlorotrifluoroethylene; (2) alkylperfluoro vinyl ethers or alkoxy alkyl perfluoro vinyl ethers; (3) perfluoroalkyl vinyl ethers such as perfluoromethyl vinyl ether, perfluoroethyl vinyl ether, perfluoropropyl vinyl ether, perfluorobuthyl vinyl ether, and perfluoroisobtyl vinyl ether; (4) perfluoroalkoxyalkyl vinyl ethers such as perfluoropropoxypropyl vinyl ether; (5) fluorine-containing (meth)acrylates such as trifluoroethyl (meth)acrylate, tetrafluoropropyl (meth)acrylate, octafluoropentyl (meth)acrylate, and heptadecafluorodecyl (meth)acrylate; and others. These compounds may be used singularly or in a combination of two or more kinds. Examples of specific products include OPSTAR TU2205 and OPSTAR TU2276 commercialized by JSR as an antireflective film forming coating material.

In the antireflective layer of the present invention, as needs arise, the ionizing radiation-curable resin, organic particles, inorganic particles, a levelling agent, a defoarming agent, a lubricant, an UV absorber, a light stabilizer, a polymerization inhibitor, a wetting dispersant, a rheology control agent, an antioxidant, an antifouling agent, an antistatic agent, and a conductive agent may be contained in the range that does not damage the effect of the invention.

Although a thickness of the antireflective layer of the present invention is usually about 80 to 120 nm, it is not particularly restricted and may be properly adjusted depending on the usage for which the antireflective film is used. For example, in the usage where the reflectance∩color hue are important, the thickness is generally adjusted to 80 to 100 nm, however, in the usage where the reflectance is important than the color hue, it is adjusted generally to 90 to 120 nm.

As was described above, in the hard coat film of the present invention, by setting in the range described above, that is, when a difference (|nx−ny|) of the refractive index (nx) of the ionizing radiation-curable resin and the refractive index (ny) of the organic fine particles contained in the hard coat layer is set to 0.03 or larger, excellent brightness irregularity suppression and excellent antiglare properties may be combined. That is, why the hard coat film of the present invention develops excellent effect like this is assumed that because the brightness irregularity due to the internal haze is suppressed, and due to the surface irregularity, development of the antiglare properties may be obtained with good balance. That is, while maintaining excellent antiglare properties, the brightness irregularity may be suppressed, and a hard coat film having excellent visibility of the display may be obtained. Furthermore, in the hard coat film of the present invention, by further adjusting an average particle size, an addition rate and the refractive index of the organic fine particles to be added, or a film thickness of the hard coat layer, the brightness irregularity due to the internal haze is suppressed, furthermore, due to the surface irregularity, the antiglare properties are developed with good balance, and the effect of the present invention tends to be readily obtained.

### EXAMPLES

An embodiment of the present invention will be described below in more detail with reference to Examples. However, the present invention is not limited to these examples as far as it does not exceed the gist of the present invention. Further, “part” and “%” are respectively parts by weight and weight % unless described otherwise below.

### Example 1

(Preparation of Hard Coat Coating Material) Into 50 parts of toluene, 2.8 parts of silicon fine particles (average particle size: 4.5 μm, refractive index: 1.42) manufactured by Momentive Performance Materials Japan Inc., as organic fine particles A, 1.2 parts of the same silicon fine particles (average particle size: 2.0 μm, refractive index: 1.42) as organic fine particles B, and an appropriate amount of a dispersant (Manufactured by BYK Co., Ltd.) were added, followed by thoroughly stirring. To this solution, 33 parts of an ionizing radiation-curable resin (Urethane acrylate manufactured by Arakawa Chemical Industries, Ltd., acryloyl group number: 12, refractive index: 1.52) and an appropriate amount of Irgacure 184 (photo polymerization initiator manufactured by BASF Corp.) were added, followed by thoroughly stirring to prepare a hard coat coating material 1.

(Preparation of Hard Coat Film)

On a TAC film (triacetyl cellulose film) having a thickness of 40 μm, the hard coat coating material 1 was applied with a Myer bar, dried at 80° C. for 1 minute, followed by curing by irradiating UV ray (light source: UV lamp manufactured by Fusion Japan Inc.) of 200 mJ/cm² under air atmosphere, and a hard coat film 1 was obtained.

### Example 2

A hard coat film 2 was prepared in the same manner as Example 1 except that in the hard coat material 1 of Example 1, as the organic fine particles A, 2.0 parts of silicon fine particles (average particle size: 4.5 μm, refractive index: 1.42) manufactured by Momentive Performance Materials Japan Inc., were added, and the organic fine particles B was not used.

### Example 3

(Lamination of Antireflective Layer)

72 parts of tert-butyl alcohol and 28 parts of the antireflective layer coating material OPSTAR JUA 204 (fluororesin, manufactured by JSR Co., Ltd.) were added, followed by thoroughly stirring to prepare an antireflective layer coating material.

The antireflective layer coating material was applied on the hard coat film 1 obtained in Example 1 with a Myer bar, after drying at 80° C. for 1 minute, UV ray of 200 mJ/cm² was irradiated under a nitrogen atmosphere, and an antireflective layer having a film thickness of about 0.1 μm was obtained. Thus, a hard coat film 3 of Example 3 was obtained.

The hard coat film obtained in each Example was evaluated as shown below, and results thereof are shown in Table 1.

(1) Refractive Index of Ionizing Radiation-curable Resin

In 50 parts of toluene, 33 parts of the ionizing radiation-curable resin used in Examples 1 to 3, and an appropriate amount of Irgacure 184 (manufactured by BASF Corp., photo polymerization initiator) were added, followed by thoroughly stirring to obtain a resin dispersion. The resin dispersion was applied on a TAC film having a thickness of 40 μm with a Myer bar, followed by drying at 80° C. for 1 minute, further followed by irradiating UV ray of 200 mJ/cm² under a nitrogen atmosphere, thus a hard coat film A having a hard coat layer A made of only the ionizing radiation-curable resin was obtained.

With a hard coat layer A surface side of the hard coat film A as an irradiation surface, by use of Filmetrics F20 (manufactured by Filmetrics Inc.), the refractive index of the hard coat layer A was measured, and this was presumed as the refractive index of the ionizing radiation-curable resin.

(2) Haze Value

A haze meter “HM150” manufactured by Murakami Color Research Laboratory was used to measure. A measurement method of the internal haze was performed in such a manner that a hard coat layer side of the hard coat film was adhered to the TAC film via a transparent adhesive to collapse an irregular shape to make flat, and the internal haze was measured in a state where the haze due to a surface shape was removed. Then, the internal haze value was subtracted from a total haze value (haze value) to obtain the external haze.

(3) Glitter (Brightness Irregularity)

Each of films was superposed on a liquid crystal display body (LCD) of the resolution of 227 ppi an entire surface of which was displayed in green, and occurrence degree of glitter of a screen was visually evaluated. By the way, on a LCD surface, a hard coat film of clear type that does not generate the glitter was arranged in advance. One that does not generate the glitter was evaluated as “5”, one having intense glitter was evaluated as “1”, that is, the closer to “5” the value is, the less intense the glitter is.

(4) Antiglare Properties

A black PET was adhered on a side opposite to the hard coat layer of the hard coat film, a fluorescent lamp was reflected on the hard coat layer, and when viewing via the hard coat film with the hard coat layer side on an observer side, a state where the reflection of the fluorescent lamp is blurred due to the light scattering to be difficult to see was visually evaluated. One where a contour of the fluorescent lamp is difficult to observe was evaluated as “5”, one where the contour is clearly reflected was evaluated as “1”, and the closer to “5” the value is, the more intense the antiglare properties are.

(5) Transmissive Sharpness

A measurement was performed by using an image clarity measurement device, ICM-1DP, manufactured by Suga Test Instruments Co., Ltd. The measurement was carried out with an optical comb having a width of 2 mm, 1 mm, 0.5 mm, and 0.125 mm, and a measurement at each width and a sum total thereof were calculated.

(6) Glossiness (60 Degree)

By using a gloss meter (GM-3D) manufactured by Murakami Color Research Laboratory, by adhering a black vinyl tape (Nitto Vinyl Tape, PROSELF No. 21 (wide type)) on a coating opposite surface, and a 60 degree glossiness was measured.

TABLE 1

| | | Example 1 | Example 2 | Example 3 |
|---|---|---|---|---|
| Refractive index of | | 1.52 | 1.52 | 1.52 |
| ionizing | | | | |
| radiation-curable resin | | | | |
| Refractive index of fine | | 1.42 | 1.42 | 1.42 |
| particles | | | | |
| Average | A (μm) | 4.5 | 4.5 | 4.5 |
| particle | B (μm) | 2.0 | — | 2.0 |
| size of | | | | |
| organic fine | | | | |
| particles | | | | |
| Total haze | (%) | 27.4 | 9.9 | 30.8 |
| Internal | (%) | 24.5 | 6.7 | 3.2 |
| haze | | | | |
| External | (%) | 2.9 | 3.2 | 27.6 |
| haze | | | | |
| Transmissive | (%) | 253 | 257 | 252 |
| sharpness | | | | |
| Glossiness | | 51 | 66 | 44 |
| Glitter | poor: 1-5: | 4.5 | 4.5 | 4.5 |
| | excellent | | | |
| Antiglare | poor: 1-5: | 3.0 | 2.5 | 3.5 |
| properties | excellent | | | |

From the results of Table 1, according to the hard coat film of the present examples, the suppression of the brightness irregularity and development of the antiglare properties due to the surface irregularity may be combined with good balance, and therefore, while maintaining excellent antiglare properties, the brightness irregularity may be suppressed, a hard coat film having excellent visibility of a display may be obtained.

### Example 4

### (Preparation of Hard Coat Coating Material)

Into 50 parts of toluene, 7 parts of silicon fine particles (average particle size: 4.5 μm, refractive index: 1.43) manufactured by Momentive Performance Materials Japan Inc., as the organic fine particles A, and 3 parts of the same silicon fine particles (average particle size: 2.0 μm, refractive index: 1.43) as the organic fine particles B were added, and 30% relative to the fine particles of the dispersant (BYK-170, Manufactured by BYK Co., Ltd.) was added, followed by thoroughly stirring. To this solution, 33 parts of an ionizing radiation-curable resin (Urethane acrylate manufactured by Arakawa Chemical Industries, Ltd., acryloyl group number: 12, refractive index: 1.52) and 5% relative to the resin of Irgacure 184 (photo polymerization initiator, manufactured by BASF Corp.) were added, furthermore, 2.5% relative to the solid content of a hindered amine-based light stabilizer (Tinuvin 292), and 0.5% relative to the solid content of a fluorine-based levelling agent (RS-75, manufactured by DIC Corporation) were added, followed by thoroughly stirring to prepare a hard coat coating material (solid content concentration: 360).

(Preparation of Hard Coat Film)

On a TAC film (triacetyl cellulose film) having a thickness of 40 μm, the hard coat coating material was applied with a Myer bar, after drying at 80° C. for 1 minute, followed by irradiating UV ray (light source: UV lamp manufactured by Fusion Japan Inc.) of 200 mJ/cm² under air atmosphere to cure, and a hard coat film of Example 4 was obtained. By the way, a coating film thickness (SEM measurement) and a coating weight of the hard coat layer were shown in Table 2.

### Example 5

A hard coat film of Example 5 was obtained by preparing in the same manner as Example 4 except that in the hard coat coating material of Example 4, an addition amount of the organic fine particles A was changed to 5 parts and the organic fine particles B were not used.

### Example 6

A hard coat film was obtained by preparing in the same manner as Example 4 except that in the hard coat coating material of Example 4, the levelling agent was changed to a siloxane-based levelling agent (BKK-UV3510, manufactured by BYK Co., Ltd.), and 0.25% relative to the solid content was added.

On the obtained hard coat film, an antireflective layer forming coating material obtained by adding 72 g of tert-butyl alcohol and 28 g of antireflective layer forming coating material OPSTAR TU2276 (fluororesin, manufactured by JSR Corporation, refractive index: 1.35) and by thoroughly stirring was applied by using Myer Bar, after drying at 80° C. for 1 minute, followed by irradiating UV ray of 200 mJ/cm² under nitrogen atmosphere to cure, and an antireflective film on which an antireflective layer of about 0.1 μm was laminated (a hard coat film of Example 6) was obtained.

### Example 7

A hard coat film was obtained by preparing in the same manner as Example 5 except that in the hard coat coating material of Example 5, the levelling agent was changed to a siloxane-based levelling agent (BKK-UV3510, manufactured by BYK Co., Ltd.), and 0.25% relative to the solid content was added.

On the obtained hard coat film, an antireflective layer was formed in the same manner as Example 6 to obtain an antireflective film (a hard coat film of Example 7).

### Example 8

A hard coat film was obtained by preparing in the same manner as Example 4 except that in the hard coat coating material of Example 4, an addition amount of the organic fine particles A was changed to 5 parts, an addition amount of the organic fine particles B was changed to 4 parts, the levelling agent was changed to a siloxane-based levelling agent (BKK-UV3510, manufactured by BYK Co., Ltd.), and 0.25% relative to the solid content was added.

On the obtained hard coat film, an antireflective layer was formed in the same manner as Example 6 to obtain an antireflective film (a hard coat film of Example 8).

### Example 9

A hard coat film of Example 9 was obtained by preparing in the same manner as Example 4 except that the organic fine particles A of Example 4 was changed to silicon fine particles (average particle size: 4.6 μm, refractive index: 1.45) and an addition amount was changed to 7 parts, and a coating amount was changed to 4.9 g/m².

### Example 10

A hard coat film of Example 10 was obtained by preparing in the same manner as Example 4 except that the organic fine particles A of Example 4 was changed to silicon fine particles (average particle size: 4.6 μm, refractive index: 1.45) and an addition amount was changed to 7 parts, and a coating amount was changed to 5.4 g/m².

### Example 11

A hard coat film of Example 11 was obtained by preparing in the same manner as Example 4 except that the organic fine particles A of Example 4 was changed to fine particles made of silicon and acrylic styrene (average particle size: 4.8 μm, refractive index: 1.47) and an addition amount was changed to 7 parts, and a coating amount was changed to 5.0 g/m².

### Example 12

A hard coat film of Example 12 was obtained by preparing in the same manner as Example 11 except that the hard coat coating material of Example 11 was used, and the coating amount was changed to 6.1 g/m².

### Example 13

A hard coat film of Example 13 was obtained by preparing in the same manner as Example 4 except that the organic fine particles A of Example 4 was changed to fine particles made of silicon and acrylic styrene (average particle size: 4.8 μm, refractive index: 1.49) and an addition amount was changed to 7 parts, and a coating amount was changed to 5.9 g/m².

### Example 14

A hard coat film of Example 14 was obtained by preparing in the same manner as Example 4 except that the organic fine particles A of Example 4 was changed to fine particles made of silicon and acrylic styrene (average particle size: 5.0 μm, refractive index: 1.45) and an addition amount was changed to 7 parts.

### Example 15

A hard coat film of Example 15 was obtained by preparing in the same manner as Example 14 except that the hard coat coating material of Example 14 was used, and the coating amount was changed to 5.9 g/m².

### Example 16

A hard coat film of Example 16 was obtained by preparing in the same manner as Example 4 except that the organic fine particles A of Example 4 was changed to fine particles made of silicon and acrylic styrene (average particle size: 5.0 μm, refractive index: 1.47) and an addition amount was changed to 7 parts, and a coating amount was changed to 5.8 g/m².

### Example 17

A hard coat film of Example 17 was obtained by preparing in the same manner as Example 4 except that the organic fine particles A of Example 4 was changed to fine particles made of silicon and acrylic styrene (average particle size: 5.0 μm, refractive index: 1.49) and an addition amount was changed to 7 parts, and a coating amount was changed to 5.0 g/m².

### Example 18

A hard coat film of Example 18 was obtained by preparing in the same manner as Example 17 except that the hard coat coating material of Example 17 was used, and the coating amount was changed to 6.0 g/m².

### Comparative Example 1

Into 50 parts of toluene, 5.5 parts of acrylic styrene fine particles (average particle size: 5.0 μm, refractive index: 1.52) as the organic fine particles A were added, and 30% relative to the fine particles of a dispersant (BYK-170, Manufactured by BYK Co., Ltd.) was added, followed by thoroughly stirring. To this solution, 33 parts of an ionizing radiation-curable resin (Urethane acrylate manufactured by Arakawa Chemical Industries, Ltd., acryloyl group number: 12, refractive index: 1.52) and 5% relative to the resin of Irgacure 184 (photo polymerization initiator manufactured by BASF Corp.) were added, furthermore, 2.5% relative to the solid content of a hindered amine-based light stabilizer (Tinuvin 292), and 0.25% relative to the solid content of a fluorine-based levelling agent (RS-75, manufactured by DIC Corporation) were added, followed by thoroughly stirring to prepare a hard coat coating material (solid content concentration: 53%). Then, the hard coat coating material was applied (coating amount: 10.0 g/m²) on the TAC film (triacetyl cellulose film) having a thickness of 40 μm in the same manner as Example 4, and the hard coat film of Comparative Example 1 was obtained.

### Comparative Example 2

A hard coat film of Comparative Example 2 was obtained by preparing in the same manner as Comparative Example 1 except that a hard coat coating material (solid content concentration: 30%) obtained by adding 40 parts of acrylic styrene fine particles (average particle size: 4.0 μm, refractive index: 1.52) as the organic fine particles A of Comparative Example 1, and 0.5% relative to the solid content of the fluorine-based levelling agent (RS-75 manufactured by DIC Corporation) was used, and a coating amount was set to 3.0 g/m².

### Comparative Example 3

A hard coat film of Comparative Example 3 was obtained by preparing in the same manner as Comparative Example 1 except that a hard coat coating material (solid content concentration: 36%) obtained by adding 7 parts of acrylic styrene fine particles (average particle size: 5.0 μm, refractive index: 1.52) as the organic fine particles A of Comparative Example 1, 3 parts of silicon fine particles (average particle size: 2.0 μm, refractive index: 1.43) as the organic fine particles B and 0.5% relative to the solid content of the fluorine-based levelling agent (RS-75 manufactured by DIC Corporation) was used, and a coating amount was set to 5.9 g/m².

Physical properties of the hard coat layers of the hard coat films obtained in the respective Examples and Comparative Examples are shown in Table 2 as a whole.

Furthermore, the hard coat films obtained in the respective Examples and Comparative Examples were evaluated as shown below, and results thereof are shown in Table 3 as a whole.

By the way, all of the “antiglare properties”, “degree of dispersion” and “diffuse reflectance” shown below become indexes when evaluating the antiglare properties.

(1) Haze Value

A haze meter “HM150” manufactured by Murakami Color Technology Research Laboratory was used to measure.

(2) Glitter (Brightness Irregularity)

Each of films was superposed on a liquid crystal display body (LCD) of the resolution of 227 ppi an entire surface of which was made to display green, and occurrence degree of glitter of a screen was visually evaluated. By the way, on a LCD surface, a hard coat film of clear type that does not generate the glitter was arranged in advance. One that does not show the glitter was evaluated as “5”, one having strong glitter was evaluated as “1”, that is, the closer to “5” the value is, the less intense the glitter is.

(3) Antiglare Properties

A black PET was adhered on a side opposite to the hard coat layer of the hard coat film, a fluorescent lamp was reflected on the hard coat layer, and when viewing via the hard coat film with the hard coat layer side on an observer side, a state where the reflection of the fluorescent lamp is blurred due to the light scattering to be difficult to see was visually evaluated. One where a contour of the fluorescent lamp is difficult to observe was evaluated as “5”, one where the contour is clearly reflected was evaluated as “1”, that is, the closer to “5” the value is, the more intense the antiglare properties are.

(4) Transmissive Sharpness

A measurement was performed by using an image clarity measurement device, ICM-1DP, manufactured by Suga Test Instruments Co., Ltd. The measurement was carried out with an optical comb having a width of 2 mm, 1 mm, 0.5 mm, and 0.125 mm, and a measurement at each width and a sum total thereof were calculated.

(5) Reflective Sharpness

A measurement of the reflective sharpness at a reflection angle of 45° was carried out using the image clarity measurement device, ICM-1DP, manufactured by Suga Test Instruments Co., Ltd. The measurement was carried out with an optical comb having a width of 2 mm, 1 mm, 0.5 mm, and 0.125 mm, and a measurement at each width and a sum total thereof were calculated.

(6) Glossiness (60 Degree)

By using a gloss meter (GM-3D) manufactured by Murakami Color Research Laboratory, by adhering a black vinyl tape (Nitto Vinyl Tape, PROSELF No. 21 (wide type)) on a coating opposite surface, and a 60 degree glossiness was measured.

(7) Maximum Cross-Section Height

The maximum cross-section height was measured with a three-dimensional surface roughness meter “VertScan2.θ” manufactured by Ryoka Systems Inc. When an average value (Ave) of heights within an evaluation area of a regional cross-section curve parameter obtained by measurement was zero, from a difference between a maximum value (P) of height in the evaluation area and a minimum value (V) of a height within the evaluation area, a maximum cross-section height (Rt) was obtained. Measurement conditions were set as shown below.

### <Optical Condition>

Camera: SONY HR-50 1/3 type

Objective: 10× (10 times)

Tube: 1× Body

Relay: No Relay

Filter: 530 white

*Light amount adjustment: automatically carrying out such that a value of a lamp is within the range of 50 to 95.

### <Measurement Condition>

Mode: Wave

Size: 640×480

Range (μm): Start (5), Stop (−10)

(8) Average Gradient Angle

An average gradient angle of an irregular part of a film surface was measured with a three-dimensional surface roughness meter “VertScan2.θ” manufactured by Ryoka Systems Inc.

(9) Scratch Resistance Load

A hard coat layer surface of each of the hard coat films was reciprocally worn 10 times by applying a weight with steel wool #0000, and a weight when a scratch began to be formed was taken as a scratch resistance load.

(10) Degree of Dispersion

By irradiating light on a hard coat film surface under the condition of projection angle of 60 degree with a variable angle photometer (GC5000L) manufactured by Nippon Denshoku Industries Co., Ltd., the brightness of the diffused light was measured for every one degree from 40 degree to 80 degree of a light receiving angle.

A value calculated from the following formula was evaluated as a “degree of dispersion”.

Degree of dispersion (%)=(t(60)/T)×100

Here, t (60): the brightness measured at a regular reflection angle of 60 degree

T: a sum total of the brightnesses t(a) at the measured respective angle of a degree

T=t(40)+t(41)+ . . . +t(79)+t(80)

(11) Diffuse Reflectance (6°/de)

By using a Hitachi spectrophotometer (U-3310), light that is incident on a hard coat film at an incident angle of 6 degree and diffused by a surface of the hard coat film was measured as “diffuse reflectance”. However, at a point to be the regular reflection (a direction of reflection angle of 6 degree), a light trap was provided on a light-receiving surface. Accordingly, in this diffuse reflectance, the regular reflection light is not contained.

TABLE 2

| | Fine particles A | | | | Fine particles B | | | | | | | |
|---|---|---|---|---|---|---|---|---|---|---|---|---|
| | | | | Difference | | | | Difference | | | | |
| | | | | of | | | | of | | | | Coating |
| | | Particle | Addition | refractive | | Particle | Addition | refractive | Film thickness SEM | | | amount |
| Table 2 | Material | size | rate | indexes | Material | size | amount | indexes | Minimum | Maximum | Average | g |
| Example 4 | Silicon | 4.5 | 7 | 0.09 | Silicon | 2 | 3 | 0.09 | 3.8 | 4.7 | 4.0 | 5.1 |
| Example 5 | Silicon | 4.5 | 5 | 0.09 | Silicon | — | — | — | 3.8 | 4.7 | 4.0 | 5.1 |
| Example 6 | Silicon | 4.5 | 7 | 0.09 | Silicon | 2 | 3 | 0.09 | 3.8 | 4.7 | 4.0 | 5.1 |
| Example 7 | Silicon | 4.5 | 5 | 0.09 | Silicon | — | — | — | 3.8 | 4.7 | 4.0 | 5.1 |
| Example 8 | Silicon | 4.5 | 5 | 0.09 | Silicon | 2 | 4 | 0.09 | 3.8 | 4.7 | 4.0 | 5.1 |
| Example 9 | Silicon | 4.6 | 7 | 0.07 | Silicon | 2 | 3 | 0.09 | 3.8 | 5 | 3.9 | 4.9 |
| Example 10 | Silicon | 4.6 | 7 | 0.07 | Silicon | 2 | 3 | 0.09 | 4.1 | 5 | 4.2 | 5.4 |
| Example 11 | Silicon + | 4.8 | 7 | 0.05 | Silicon | 2 | 3 | 0.09 | 3.54 | 5 | 3.7 | 5.0 |
| | Acrylic | | | | | | | | | | | |
| | styrene | | | | | | | | | | | |
| Example 12 | Silicon + | 4.8 | 7 | 0.05 | Silicon | 2 | 3 | 0.09 | 4.3 | 5 | 4.5 | 6.1 |
| | Acrylic | | | | | | | | | | | |
| | styrene | | | | | | | | | | | |
| Example 13 | Silicon + | 4.8 | 7 | 0.03 | Silicon | 2 | 3 | 0.09 | 4.2 | 5 | 4.2 | 5.9 |
| | Acrylic | | | | | | | | | | | |
| | styrene | | | | | | | | | | | |
| Example 14 | Silicon + | 5 | 7 | 0.07 | Silicon | 2 | 3 | 0.09 | 3.4 | 4.5 | 4.0 | 5.1 |
| | Acrylic | | | | | | | | | | | |
| | styrene | | | | | | | | | | | |
| Example 15 | Silicon + | 5 | 7 | 0.07 | Silicon | 2 | 3 | 0.09 | 4.0 | 4.4 | 4.2 | 5.9 |
| | Acrylic | | | | | | | | | | | |
| | styrene | | | | | | | | | | | |
| Example 16 | Silicon + | 5 | 7 | 0.05 | Silicon | 2 | 3 | 0.09 | 4.4 | 5.2 | 4.8 | 5.8 |
| | Acrylic | | | | | | | | | | | |
| | styrene | | | | | | | | | | | |
| Example 17 | Silicon + | 5 | 7 | 0.03 | Silicon | 2 | 3 | 0.09 | 4.0 | 5.2 | 4.6 | 5.0 |
| | Acrylic | | | | | | | | | | | |
| | styrene | | | | | | | | | | | |
| Example 18 | Silicon + | 5 | 7 | 0.03 | Silicon | 2 | 3 | 0.09 | 4.3 | 5.2 | 4.7 | 6.0 |
| | Acrylic | | | | | | | | | | | |
| | styrene | | | | | | | | | | | |
| Comparative | Acrylic | 5.0 | 5.5 | 0.00 | — | — | — | — | 7.8 | 8 | 8.0 | 10.0 |
| example 1 | styrene | | | | | | | | | | | |
| Comparative | Acrylic | 4.0 | 40 | 0.00 | — | — | — | — | 2 | 4 | 4.0 | 3.0 |
| example 2 | styrene | | | | | | | | | | | |
| Comparative | Acrylic | 5 | 7 | 0 | Silicon | 2 | 3 | 0.09 | 4 | 5 | 4.1 | 5.9 |
| example 3 | styrene | | | | | | | | | | | |

TABLE 3

| | | | | | | | | Diffuse | Scratch | | | |
|---|---|---|---|---|---|---|---|---|---|---|---|---|
| | | Transmissive | | Gradient | | Degree of | Reflective | reflectance | resistance | | | |
| Table 3 | Haze | sharpness | Glossiness | angle | Rt | dispersion | sharpness | 6°/de | load | | | |
| Example | % | % | % | degree | μm | % | % | % | g | | Glitter | Antiglare properties |
| Example 4 | 28 | 280 | 53 | 1.18 | 1.33 | 51% | 59 | 2.1 | 265 | g | 4.3 | 2.5 |
| Example 5 | 10 | 280 | 72 | 1.04 | 1.17 | 53% | 68 | 1.8 | 300 | g | 4.3 | 2.5 |
| Example 6 | 30 | 240 | 46 | 1.04 | 0.99 | 50% | 98 | 1.6 | 265 | g | 4.3 | 3 |
| Example 7 | 12 | 294 | 48 | 0.88 | 1.21 | 65% | 105 | 1.5 | 265 | g | 4.3 | 2.3 |
| Example 8 | 24 | 301 | 49 | 0.54 | 0.54 | 62% | 87 | 1.3 | 265 | g | 4.3 | 2.5 |
| Example 9 | 35.0 | 135.1 | 39 | 1.86 | 1.77 | 22% | 63.0 | 2.8 | 200 | g | 4 | 4 |
| Example 10 | 34.9 | 211.4 | 58 | 1.13 | 1.01 | 45% | 67.1 | 2.1 | 300 | g | 4.3 | 2.8 |
| Example 11 | 36.5 | 83.7 | 33 | 2.19 | 2.28 | 16% | 70.0 | 2.9 | <200 | g | 4 | 5 |
| Example 12 | 33.8 | 225.3 | 53 | 1.20 | 0.95 | 46% | 64.2 | 2.2 | 200 | g | 4.3 | 2.9 |
| Example 13 | 30.9 | 172.5 | 47 | 1.33 | 1.57 | 37% | 65.7 | 2.4 | <200 | g | 4.3 | 3 |
| Example 14 | 31.8 | 66.2 | 38 | 1.92 | 2.71 | 15% | 65.8 | 2.6 | 300 | g | 3 | 4.5 |
| Example 15 | 33.7 | 155.1 | 56 | 1.25 | 2.34 | 31% | 61.1 | 2.1 | 300 | g | 4.3 | 3.5 |
| Example 16 | 32.5 | 133.2 | 51 | 1.44 | 1.62 | 30% | 59.4 | 2.3 | 200 | g | 4 | 3.5 |
| Example 17 | 35.2 | 44.5 | 29 | 2.94 | 3.60 | 10% | 81.3 | 3.2 | <200 | g | 3 | 5 |
| Example 18 | 31.3 | 147.5 | 50 | 1.55 | 2.01 | 27% | 67.2 | 2.5 | <200 | g | 4.3 | 3.5 |
| Comparative | 1.4 | 350 | 83 | 0.42 | 0.38 | 84% | 94 | 1.2 | 1000 | g≤ | 4.5 | 1.5 |
| example 1 | | | | | | | | | | | | |
| Comparative | 78.8 | 151 | 5 | 8.69 | 4.10 | 22% | 353 | 5.2 | <200 | g | 3.5 | 4.0 |
| example 2 | | | | | | | | | | | | |
| Comparative | 27.5 | 138.5 | 45 | 1.78 | 1.61 | 23% | 65.7 | 2.6 | <200 | g | 4.3 | 1.9 |
| example 3 | | | | | | | | | | | | |

From results of Table 3, according to the hard coat film of the present examples, a hard coat film that may combine the suppression of the brightness irregularity and development of the antiglare properties due to the surface irregularity with good balance, and therefore, while maintaining excellent antiglare properties (evaluation due to the antiglare properties, degree of dispersion, and the diffuse reflectance), may suppress the brightness irregularity, and has excellent visibility of the display may be obtained. Furthermore, the hard coat films of the present examples are provided with excellent hardness property (scratch resistance) while suppressing the haze value to a certain extent.

On the other hand, in the hard coat films of comparative examples, it is difficult to combine the suppression of the brightness irregularity and the development of the antiglare properties due to the surface irregularity with good balance, or the hardness property (scratch resistance) is poor.

1. A hard coat film comprising:
a hard coat layer containing organic fine particles and an ionizing radiation-curable resin on a transparent film,
wherein a difference (|nx−ny|) of the refractive index (nx) of the ionizing radiation-curable resin and the refractive index (ny) of the organic fine particles is 0.03 or larger.

2. The hard coat film comprising:
a hard coat layer containing organic fine particles and an ionizing radiation-curable resin on a transparent film,
wherein a difference (|nx−ny|) of the refractive index (nx) of the ionizing radiation-curable resin and the refractive index (ny) of the organic fine particles is 0.03 or larger;
a haze value of the hard coat film is 5% or larger and 50% or smaller; and
the scratch resistance load is 200 g or larger.

3. The hard coat film according to claim 1 comprising two or more kinds of the organic fine particles having different average particle sizes, wherein an organic fine particles A showing a maximum average particle size contained in the hard coat layer has an average particle size of 2 μm or larger and 5 μm or smaller.

4. The hard coat film according to claim 1, wherein an average gradient angle of an irregularity of a surface of the hard coat film is 2.1 degree or smaller.

5. The hard coat film according to claim 1, wherein, when an average value of heights in an evaluation area of the surface of the hard coat film is set to zero, a maximum cross-section height represented by a difference of a maximum value of a height in the evaluation area and a minimum value of a height in the evaluation area is 3.0 μm or smaller.

6. The hard coat film according to claim 1, wherein the diffuse reflectance of the hard coat film is 4.0% or smaller.

7. The hard coat film according to claim 1, wherein the transmissive sharpness of the hard coat film is 155% or larger and 320% or smaller, and the glossiness is 30% or larger and 80% or smaller.

8. The hard coat film according to claim 1, wherein a haze value of the hard coat film is 8% or larger and 35% or smaller, and an external haze value is 1% or larger and 30% or smaller.

9. The hard coat film according to claim 1, wherein an antireflective layer containing a fluororesin is laminated on the hard coat layer.

10. The hard coat film according to claim 1, wherein the transparent film is a triacetyl cellulose film.
